(19) United States
(12) Patent Application Publication
(10) Pub. No.: US 2015/0355077 A1
(43) Pub. Date: Dec. 10, 2015

(54) CARTRIDGE FOR INSPECTION APPARATUS AND METHOD OF RETAINING LIQUID

(71) Applicants: Kabushiki Kaisha Toshiba, Minato-ku (JP); Toshiba Medical Systems Corporation, Otawara-shi (JP)

(72) Inventors: Ichiro TONO, Otawara (JP); Tomohiro TAKASE, Otawara (JP)

(73) Assignees: Kabushiki Kaisha Toshiba, Minato-ku (JP); Toshiba Medical Systems Corporation, Otawara-shi (JP)

(21) Appl. No.: 14/730,438

(22) Filed: Jun. 4, 2015

(30) Foreign Application Priority Data
Jun. 6, 2014 (JP) 2014-118206

(51) Int. Cl. G01N 21/03; G01N 21/05; B01L 3/00; G01N 21/11

(52) U.S. Cl. CPC G01N 21/0303; G01N 21/11; G01N 21/05; B01L 3/502; G01N 2201/022; G01N 2201/068; B01L 2300/0877; B01L 2300/12; B01L 2300/0848

(57) ABSTRACT

A cartridge for inspection apparatus includes a container, a flow path, and a reservoir. The container is configured to contain a liquid and includes a bottom surface having a functional layer that is reactive to a test sample contained in the liquid. The flow path includes an opening above the container and introduces the liquid that has flowed therein from the opening to the container. The reservoir is configured to retain the liquid, and includes an opening that is larger than the opening of the flow path and a bottom surface that is connected to the opening of the flow path.

### CROSS-REFERENCE TO RELATED APPLICATION

This application is based upon and claims the benefit of priority from Japanese Patent Application No. 2014-118206, filed Jun. 6, 2014; the entire contents of which are incorporated herein by reference.

### FIELD

Embodiments described herein relate generally to a cartridge for inspection apparatus and a method of retaining liquid.

### BACKGROUND

There are known measurement systems. Such a measurement system includes a measurement device that is equipped with a cartridge for inspection apparatus and performs sensing of a test subject contained in the cartridge to acquire information thereof, thus accomplishing a measurement. As an example of the cartridge for inspection apparatus may be cited an optical sensor chip. The measurement device makes the light from the light source enter the inside of the optical sensor chip. Having entered in the optical sensor chip, the light is affected by the test subject and is output to the measurement device. In the measurement system, for example, the measurement device receives the output light and acquires information on the test subject therefrom.

The cartridge for inspection apparatus includes therein a container that is capable of containing a sample liquid. The cartridge has an opening on its upper surface to allow a sample liquid to be contained in the container. The sample liquid may be introduced into the container, for example, through a syringe having one end inserted in the opening.

### BRIEF DESCRIPTION OF THE DRAWINGS

FIG. 1 is a perspective view of an example of a cartridge for inspection apparatus according to a first embodiment;

FIG. 2 is another perspective view of an example of the cartridge of the first embodiment;

FIG. 3 is a top view of an example of the cartridge of the first embodiment;

FIG. 4 is a cross-sectional view of the example of the cartridge of the first embodiment;

FIG. 5 is a top view of another example of the cartridge of the first embodiment;

FIG. 6 is a schematic diagram illustrating how to retain liquid in the cartridge;

FIG. 7 is a schematic diagram illustrating how to retain liquid in the cartridge;

FIG. 8 is a schematic diagram illustrating how to retain liquid in the cartridge;

FIG. 9 is a schematic diagram illustrating how to retain liquid in the cartridge;

FIG. 10 is a schematic diagram illustrating how to retain liquid in the cartridge;

FIG. 11 is a schematic diagram illustrating how to retain liquid in the cartridge;

FIG. 12 is a top view of a cartridge for inspection apparatus according to a first modification;

FIG. 13 is a cross-sectional view of the cartridge of the first modification;

FIG. 14 is a cross-sectional view of a cartridge for inspection apparatus according to a second modification;

FIG. 15 is a cross-sectional view of a cartridge for inspection apparatus according to a third modification;

FIG. 16 is a cross-sectional view of a cartridge for inspection apparatus according to a fourth modification;

FIG. 17 is a top view of a cartridge for inspection apparatus according to a fifth modification;

FIG. 18 is a top view of an example of a cartridge for inspection apparatus according to a second embodiment;

FIG. 19 is a top view of an example of a cartridge for inspection apparatus according to a third embodiment;

FIG. 20 is a top view of an example of a cartridge for inspection apparatus according to a fourth embodiment;

FIG. 21 is a cross-sectional view of an example of the cartridge of the fourth embodiment;

FIG. 22 is a top view of an example of a cartridge for inspection apparatus according to a fifth embodiment;

FIG. 23 is a top view of another example of the cartridge of the fifth embodiment; and

FIG. 24 is a top view of an example of a cartridge for inspection apparatus according to a sixth embodiment.

### DETAILED DESCRIPTION

In general, according to one embodiment, a cartridge for inspection apparatus includes a container, a flow path, and a reservoir. The container is configured to contain a liquid and includes a bottom surface having a functional layer that is reactive to a test sample contained in the liquid. The flow path includes an opening above the container and introduces the liquid that has flowed therein from the opening to the container. The reservoir is configured to retain the liquid, and includes an opening that is larger than the opening of the flow path and a bottom surface that is connected to the opening of the flow path.

### First Embodiment

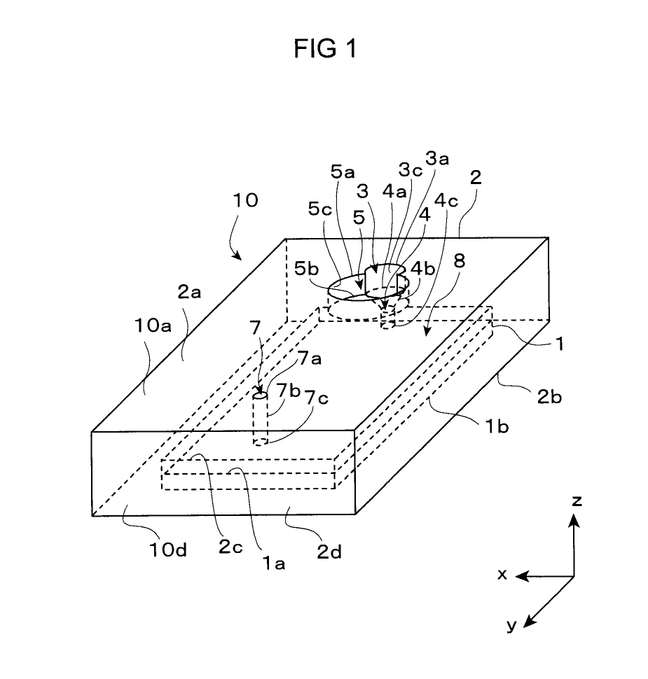

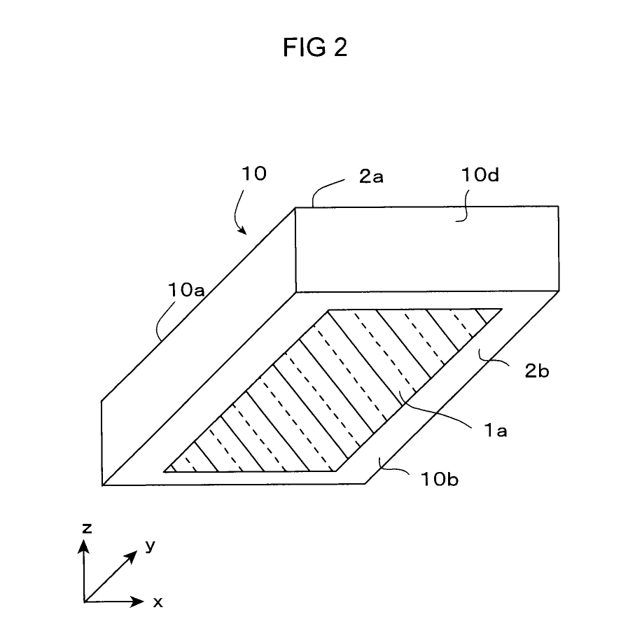

With reference to FIGS. 1 and 2, a description is given of a configuration of a cartridge 10 for inspection apparatus (hereinafter, simply referred to as “cartridge”) according to a first embodiment. FIGS. 1 and 2 are perspective views of an example of the cartridge 10 of this embodiment. FIG. 1 illustrates the cartridge 10 viewed from an obliquely upward direction. In FIG. 1, portions indicated by broken lines represent the configuration of the inside of the cartridge 10. FIG. 2 illustrates the cartridge 10 viewed from an obliquely downward direction. In the drawings, the x direction corresponds to the lateral direction of the cartridge 10, the y direction corresponds to the longitudinal direction of the cartridge 10, and the z direction corresponds to the vertical direction.

### [Cartridge for Inspection Apparatus]

As illustrated in FIGS. 1 and 2, the cartridge 10 includes a chip 1 and a housing 2. The cartridge 10 is formed integrally with the chip 1 such that a space that serves as a container 8 is defined above the chip 1. The chip 1 may be detachably attached to the cartridge 10. The housing 2 is formed substantially in a rectangular parallelepiped shape having an upper surface 2a and a bottom surface 2b. The chip 1 is formed in a plate-like shape having an upper surface 1a and a bottom surface 1b. For example, the bottom surface 1b and the bottom surface 2b are located on the same plane to form a bottom surface 10b of the cartridge 10. The bottom surface 1b is arranged, for example, to cover an opening formed in the bottom surface 2b. The bottom surface 10b of the cartridge 10 includes the bottom surface 1b and the bottom surface 2b surrounding it. That is, in the cartridge 10, the chip 1 forms at least part of the bottom surface 10b. The chip 1 includes a transparent substrate having translucency. Incidentally, the bottom surface 1b need not necessarily be located on the same plane as the bottom surface 2b as long as it is arranged in parallel to the bottom surface 2b. For example, the bottom surface 1b may be located slightly above or below the bottom surface 2b. If the bottom surface 1b is recessed from the bottom surface 2b even only by a small amount, for example, while the bottom surface 2b is in contact with a placement surface when the cartridge 10 is mounted thereon, the bottom surface 1b is separate from the placement surface and does not touch it. Accordingly, the bottom surface 1b is less likely to get dirty and damaged due to the contact with the placement surface.

The housing 2 includes therein the container 8 to retain a sample liquid. The container 8 is a space to accommodate a sample liquid, and the upper surface 1a of the chip 1 forms the bottom surface among surfaces that define the space. Hereinafter, the upper surfaces 2a and 10a as well as the bottom surfaces 2b and 10b are sometimes described as the same surfaces.

The upper surface 2a includes a first recessed surface 5a, a second recessed surface 3a, an upper opening 4a, and an upper opening 7a. The first recessed surface 5a defines a recess 5, which is an open space at least having an opening at its upper part. The second recessed surface 3a defines a communicating part 3, which is an open space at least having an opening at its upper part. The upper opening 4a forms the upper end of a liquid inlet hole 4b. The liquid inlet hole 4b communicates between the communicating part 3 and the container 8. The liquid inlet hole 4b defines a passage for introducing a liquid retained in the recess 5 to the container 8, i.e., a flow path 4. The upper opening 7a forms the upper end of a through hole 7b. The through hole 7b is a passage for discharging the air in the container 8 to the outside.

The recess 5 functions as a first reservoir capable of retaining a predetermined amount of liquid. The liquid is retained in the first recessed surface 5a and thereby stored. The liquid may be of any kind, and examples of the liquid include a sample liquid that contains a test subject. The first recessed surface 5a includes a bottom surface 5b and a side surface 5c. For example, the liquid is dropped from above to the bottom surface 5b to retain it in the recess 5. On this occasion, the bottom surface 5b functions as a reservoir surface including a liquid dropping position. The liquid dropping position may be, for example, the center of the bottom surface 5b.

The communicating part 3 is a space that communicates between the recess 5 and the flow path 4. The second recessed surface 3a includes at least a side surface 3c. The side surface 3c is adjacent to the side surface 5c. A side opening 5d is formed in an adjacent portion between the communicating part 3 and the recess 5. Thus, a single space, the side of which is enclosed by a side surface including the side surfaces 3c and 5c, is defined on the upper surface 2a. Incidentally, for example, the vertical position of the bottom of the communicating part 3 coincides with that of the bottom surface 5b of the first recessed surface 5a.

The upper opening 4a is arranged in the bottom of the communicating part 3. The vertical position of the upper opening 4a coincides with that of the bottom surface 5b. For example, the upper opening 4a extends over the entire bottom. In this case, the side surface 3c constitutes the second recessed surface 3a. The upper opening 4a may be arranged in part of the bottom, for example. In this case, the second recessed surface 3a includes the side surface 3c and the bottom.

The liquid inlet hole 4b includes a lower opening 4c besides the upper opening 4a. The liquid inlet hole 4b extends upward from the container 8 and has an opening at its upper end. The lower opening 4c is located in the boundary between the liquid inlet hole 4b and the container 8. The lower opening 4c is arranged in a surface 2c facing the chip 1 among surfaces that define the container 8. The lower opening 4c is located below the upper opening 4a. This defines the flow path 4 that serves as a through passage communicating between the recess 5 and the container 8. The flow path 4 is a passage (route) for introducing the liquid. The liquid is introduced from the recess 5 to the container 8 through the flow path 4. In other words, the liquid flowing out of the recess 5 to the communicating part 3 is introduced to the container 8 through the flow path 4. On this occasion, the flow path 4 or a space extending from the communicating part 3 to the flow path 4 functions as a second reservoir capable of retaining a predetermined amount of liquid introduced from the first reservoir (the recess 5).

The upper opening 7a is located in a position away from the liquid inlet hole 4b on the upper surface 2a. The through hole 7b includes a lower opening 7c besides the upper opening 7a. The through hole 7b extends upward from the container 8 and has an opening at its upper end. The lower opening 7c corresponds to a portion of the through hole 7b arranged in the container 8. The lower opening 7c is arranged in the surface 2c facing the chip 1 among the surfaces that define the container 8. The lower opening 7c is located below the upper opening 7a. This defines an air discharge path 7 that serves as a through passage communicating between the recess 5 and the container 8. The air discharge path 7 is a passage (route) for letting the air (gas) flow. When the liquid is introduced through the flow path 4 into the container 8, the air inside the container 8 is discharged to the outside through the air discharge path 7.

In the cartridge 10, liquid is supplied from above and retained in the first reservoir. When the amount of the liquid exceeds a predetermined value, part of the liquid is transferred to the second reservoir. The liquid transferred to the second reservoir is not directly transferred to the container 8, and is retained in the second reservoir or in a space extending from the first reservoir to the second reservoir. When the amount of the liquid thus retained exceeds a predetermined value by another supply of the liquid, the liquid is introduced to the container 8 at a time. On this occasion, if the amount of the liquid exceeds the capacity of the container 8, the container 8 is filled with the liquid. Along with the introduction of the liquid, the air in the container 8 is discharged to the outside through the air discharge path 7.

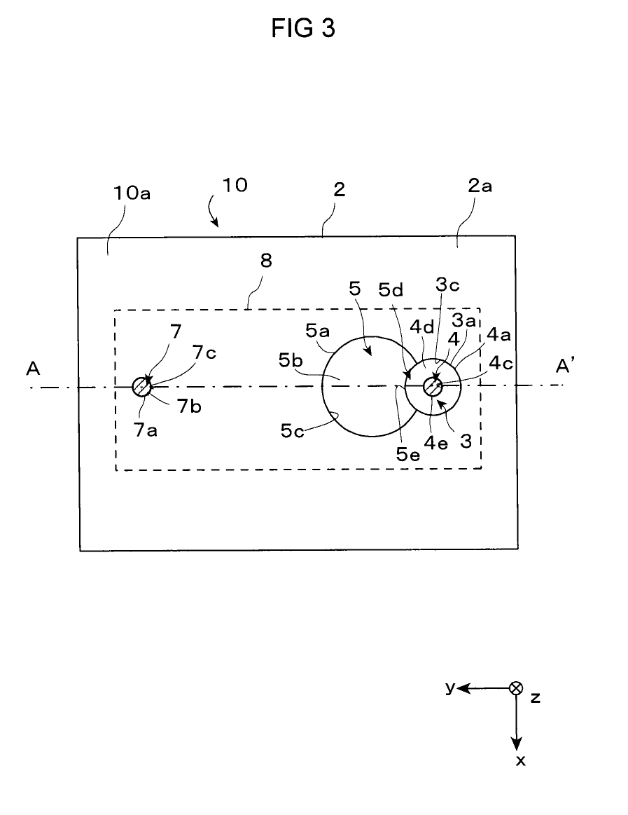

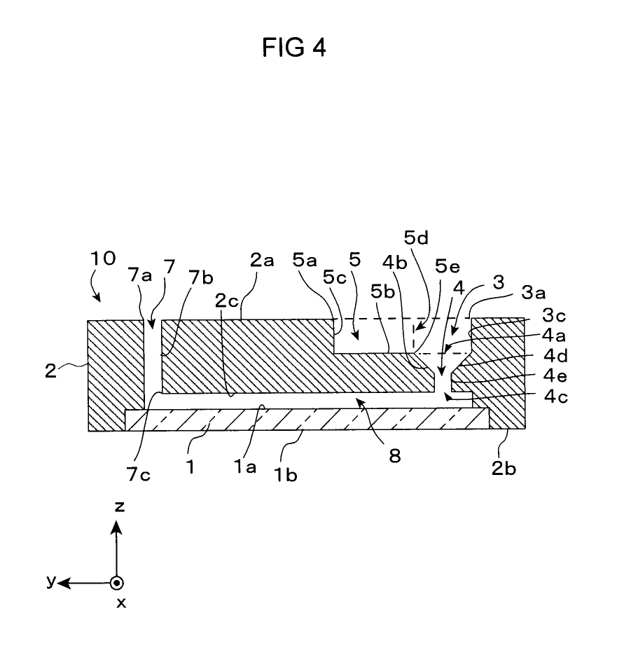

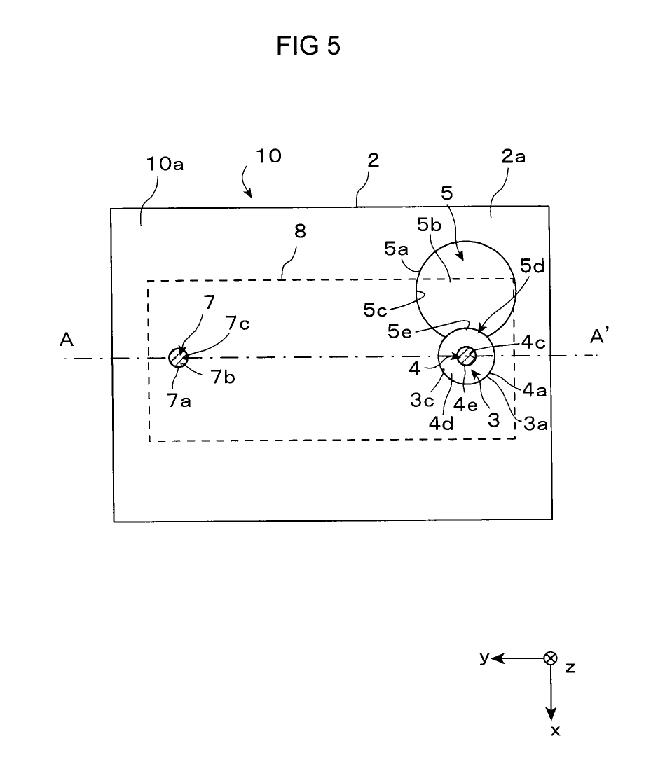

With reference to FIGS. 3 to 5, the configuration of the cartridge 10 of the embodiment is described in detail. FIG. 3 is a top view of an example of the cartridge 10 of the embodiment. FIG. 4 is a cross-sectional view of the example of the cartridge 10 of the embodiment. FIG. 5 is a top view of another example of the cartridge 10 of the embodiment. FIG. 4 illustrates a cross-sectional view taken along line A-A′ of FIG. 3. In FIG. 3 (top view), a shaded area is intended to clearly indicate a through hole, not a cross section. In addition, in FIG. 4 (cross-sectional view), broken line indicates segmentation of the space, not the configuration of the cartridge 10. The same applies to the following.

### [Chip]

In the chip 1, light enters inside the chip 1 from the outside through the bottom surface 1b, and the light is emitted from the inside of the chip 1 to the outside. The chip 1 is formed, for example, substantially in a rectangular parallelepiped shape. The chip 1 is arranged such that the bottom surface 1b is located on the same plane as the bottom surface 10b of the cartridge 10. When formed substantially in a rectangular parallelepiped shape, for example, the chip 1 is arranged such that its longitudinal direction is in parallel to the longitudinal direction of the cartridge 10, while the lateral direction of the chip 1 is in parallel to the lateral direction of the cartridge 10. However, this is not so limited. The longitudinal direction of the chip 1 may be in parallel to the lateral direction of the cartridge 10, while the lateral direction of the chip 1 may be in parallel to the longitudinal direction of the cartridge 10.

The chip 1 is configured such that light incident thereon is affected by a component contained in the sample liquid in the container 8, and the affected light is emitted therefrom.

As an example of the chip 1 may be cited an optical waveguide sensor. The optical waveguide sensor includes, for example, a transparent substrate, an entrance grating, an exit grating, an optical waveguide part, and a functional layer. The transparent substrate is configured to allow light, in particular, visible light, to pass therethrough. Light enters inside the optical waveguide sensor from the outside through the transparent substrate, and the light is emitted from the inside of the optical waveguide sensor to the outside through the transparent substrate. The transparent substrate forms, for example, the bottom surface 1b of the chip 1. The entrance grating and the exit grating are adjacent to the optical waveguide part, and located away from each other. The optical waveguide part is laminated on a surface of the transparent substrate, which is opposite to the surface that forms the bottom surface 1b. The optical waveguide part includes, for example, a slab optical waveguide formed in a plate-like shape. The functional layer is formed on a surface of the optical waveguide part opposite to the laminated surface. The surface of the optical waveguide part having the functional layer corresponds to the bottom surface among the surfaces that define the container 8. The functional layer has a function of reacting to a test subject. The test subject is contained in the sample liquid (corresponding to one example of the liquid) retained in the container 8.

The entrance grating changes the direction of light that has entered inside the optical waveguide sensor through the transparent substrate. Thereby, the light propagates inside the optical waveguide part. The light is affected due to the reaction of the functional layer to the test subject. The exit grating changes the direction of the light affected. Thus, the light is emitted to the outside through the transparent substrate. The measurement device detects the light, and processes information of the detected light to acquire the properties of the test subject (test sample) contained in the sample liquid retained in the container 8. For example, the measurement device may detect the intensity of the light emitted from the exit grating and obtain information on the density of the test subject contained in the sample liquid retained in the container 8 from the information detected.

Examples of chemical sensors that can be used as the chip 1 include surface plasmon sensors. The chip 1 may be replaced by a sensor having a signal transmission property other than the chemical sensors. The chip 1 may be replaced by, for example, an electrode sensor such as a redox sensor that transmits electrical signals.

### [Housing]

The housing 2 may be made of any material, and the material may have a light resistance, insulation property, moisture-proof property, and the like. As the material of the housing 2, for example, variety of resin materials may be used. Examples of the resin materials include acrylic that can be easily molded into any shape.

The housing 2 may also be made of a material having a high light absorption property and light-barrier property. The housing 2 may be made of a dark material such as a black material. If made of a dark material, the housing 2 can prevent light from entering the chip 1 therethrough from the outside. The housing 2 can also absorb scattered light, stray light, and the like. The scattered light, stray light, and the like are derived from the light that has entered inside the chip 1. Accordingly, it is possible to reduce the light that is irrelevant to measurement from among the light emitted from the bottom surface 1b. This contributes to improving the accuracy of the measurement.

### [Container]

Together with the chip 1, the housing 2 forms the container 8. The container 8 is a closed space enclosed by the upper surface 1a and the surface 2c of the housing 2 facing thereto. The housing 2 may provide the side surface among the surfaces that define the container 8. For example, if the housing 2 abuts on the side of the chip 1, it can seal the sample liquid contained in the container 8. The housing 2 may cover the edge of the upper surface 1a of the chip 1 to form the container 8. The container 8 as a closed space is connected to the liquid inlet hole 4b for communication with the outside, and thus can take liquid from the outside.

For example, when the chip 1 is made of an optical waveguide sensor, the container 8 may be located between the entrance grating and the exit grating in the longitudinal direction (y direction) of the chip 1. Besides, in the horizontal direction, the container 8 is in the same shape as the chip 1 or in a shape substantially similar to the chip 1. For example, if the chip 1 is formed in a plate-like shape, the container 8 has a rectangular parallelepiped space, and the longitudinal and lateral directions of the container 8 coincide with those of the chip 1.

### [Recess]

The recess 5 is an open space formed on the upper surface 2a of the housing 2. The recess 5 is formed of the bottom surface 5b and the side surface 5c. With this, the first recessed surface 5a as a whole has a well shape of a predetermined depth from the upper surface 2a. To supply a liquid to the cartridge 10, the liquid is dropped from above to the bottom surface 5b. The bottom surface 5b is formed of, for example, a horizontal plane parallel to the horizontal direction (xy direction). The bottom surface 5b may be of, for example, a circular shape. This is because, when the liquid is dropped to the bottom surface 5b to be retained, the droplet becomes spherical due to surface tension. In this case, the bottom surface 5b is configured to allow a liquid to adhere to and wet it. This configuration may be obtained experimentally. Besides, for example, the side surface 5c is formed in a shape extending upward. With this, the recess 5 is formed to have substantially a columnar shape. The bottom surface 5b may be provided with a dent (not illustrated) in its center (e.g., center of curvature of part of the outer periphery of the bottom surface 5b other than an edge 5e). The dent enables the bottom surface 5b to retain more liquid. In addition, when the liquid dropping position is located in the center of the bottom surface 5b, the dent may serve as a landmark for dropping a liquid to the bottom surface 5b. Incidentally, the upper surface 10a includes the upper surface 2a and the bottom surface 5b.

### [Communicating Part]

The communicating part 3 is a space that is formed adjacent to the recess 5 on the upper surface 2a. Part of the side surface of the communicating part 3 abuts on part of the side of the recess 5. The abutting side forms the side opening 5d on the upper surface 2a. The bottom of the communicating part 3 communicates with the flow path 4. In this case, the upper opening 4a extends over the entire bottom of the communicating part 3. With this, the communicating part 3 forms an open space enclosed by the side surface 3c. Thus, the communicating part 3 is defined as an open space having the side surface 3c and a side opening adjacent to the upper part, the lower part, and the recess 5. When the upper opening 4a has a circular shape, the communicating part 3 is formed to have substantially a columnar shape of the same height as the recess 5. When the bottom surface 5b has a circular shape, the side opening 5d is formed in a region where a columnar space corresponding to the recess 5 is overlapped with a columnar space corresponding to the communicating part 3.

### [Flow Path]

The flow path 4 is a passage (route) formed by communicating between the upper opening 4a and the lower opening 4c with the liquid inlet hole 4b serving as a through passage. The upper opening 4a and the lower opening 4c are formed in, for example, a circular shape. Thus, the flow path 4 forms a circular tube channel with less flow loss. Besides, the line segment that joins between the center of the upper opening 4a and the center of the lower opening 4c is in parallel to the vertical direction (z direction). As illustrated in FIG. 4, the area of the upper opening 4a is larger than that of the lower opening 4c. That is, the liquid inlet hole 4b becomes narrower from the upper opening 4a to the size of the lower opening 4c in a tapered part 4d that forms the upper portion of the liquid inlet hole 4b. The tapered part 4d can reduce unnecessary liquid remaining in the liquid inlet hole 4b.

The liquid inlet hole 4b that forms the flow path 4 includes the tapered part 4d having an inclined surface, which forms the upper portion of the liquid inlet hole 4b, and a straight tube part 4e that forms the lower portion. As a whole, the flow path 4 is formed in a funnel shape. The funnel-shaped flow path 4 reduces the pressure loss of the flow of liquid from the communicating part 3 to the upper opening 4a. The vertical length of the straight tube part 4e may be longer than that of the tapered part 4d. In addition, the vertical length of the side surface 5c may be longer than the vertical distance between the upper opening 4a and the lower opening 4c. Further, the vertical length of the side surface 5c may be longer than the vertical length of the straight tube part 4e, and the vertical length of the straight tube part 4e may be longer than the vertical length of the tapered part 4d. Note that the vertical length of the straight tube part 4e may be shorter than the vertical length of the tapered part 4d.

### [Air Discharge Path]

The air discharge path 7 is a passage (flow path) formed by communicating between the upper opening 7a on the upper surface 2a and the lower opening 7c on the surface 2c with the through hole 7b. The upper opening 7a and lower opening 7c are formed in, for example, a circular shape. With this, the air discharge path 7 forms a circular tube channel having less flow loss. The line segment that joins between the center of the upper opening 7a and the center of the lower opening 7c is in parallel to the vertical direction (z direction). The upper opening 7a may have the same area as the lower opening 7c. Thus, the through hole 7b can be formed in a straight tube shape that extends in the vertical direction. The upper opening 7a may have the same area as the lower opening 4c of the flow path 4, for example.

### [Positional Relationship Among the Recess, the Communicating Part, and the Flow Path]

As described above, the recess 5 and the communicating part 3 abut on each other, and the communicating part 3 and the flow path 4 abut on each other. Thus, these spaces form a continuous space.

For example, as illustrated in FIG. 3, in the top view of the cartridge 10, the recess 5, the communicating part 3, the flow path 4 that is coaxial with the communicating part 3, and the air discharge path 7 are formed on the upper surface 10a of the cartridge 10. The recess 5 and the communicating part 3 overlap with each other in their abutting portions, and the overlapped part forms the side opening 5d. The bottom surface 5b has a shape lacking the overlapped part. Specifically, the bottom surface 5b has a circular shape lacking part of a circle. The upper opening 4a has a circular shape with a diameter smaller than that of the bottom surface 5b. The upper opening 7a of the air discharge path 7 has a circular shape as large as or smaller than the upper opening 4a. When viewed from the top, the side surface 3c has an outer periphery in the same circular shape as the outer periphery of the upper opening 4a. The side surface 3c has an opening as the side opening 5d in a portion that overlaps with the recess 5.

Described below is the positional relationship among the communicating part 3 (the flow path 4), the recess 5, and the air discharge path 7 in the top view of the cartridge 10. On the upper surface 2a, for example, the communicating part 3 (the flow path 4), the recess 5, and the air discharge path 7 are arranged in this order from the vicinity of one longitudinal end of the container 8 (y direction) to the other end. The recess 5 and the communicating part 3 abut on each other. The air discharge path 7 is located away from the recess 5 and the communicating part 3. The flow path 4 is located near the one longitudinal end of the container 8 in a region above the container 8 on the upper surface 2a (e.g., a region encircled by broken line in FIG. 3). In this case, the air discharge path 7 is located near the other longitudinal end of the container 8 in the region.

For example, the upper opening 4a, the bottom surface 5b, and the upper opening 7a are arranged in a straight line in the x direction (the lateral direction of the container 8). That is, in the x direction (the lateral direction of the container 8) on the upper surface 2a, they are arranged such that the line segments that connect the center of the recess 5, the center of the upper opening 4a, and the center of the upper opening 7a lie in the same straight line. Further, the straight line coincides with the center axis of the container 8 in the lateral direction.

The positional relationship among the communicating part 3 (the flow path 4), the recess 5, and the air discharge path 7 is not limited as described above. That is, the communicating part 3 (the flow path 4), the recess 5, and the air discharge path 7 need not necessarily be arranged in a straight line. For example, as illustrated in FIG. 5, the recess 5 and the communicating part 3 (the flow path 4) may be arranged alongside of each other in the lateral direction of the container 8 (x direction).

In the y direction (the longitudinal direction of the container 8), the upper opening 4a has an overlap with the bottom surface 5b. Thus, the bottom surface 5b has a partial circular shape that lacks a portion overlapping with the upper opening 4a for forming a full circle. When the upper opening 4a and the bottom surface 5b are arranged in a straight line, the edge 5e of the bottom surface 5b is formed by an arc that is part of the outer periphery of the upper opening 4a. The curvature change of the arc is equal to that of the arc formed by the other edge of the bottom surface 5b. In addition, the curvature radius of the arc is smaller than that of the other edge of the bottom surface 5b.

Further, as illustrated in FIG. 4, the chip 1 is formed to have a rectangular vertical cross section. In the cross section, the recess 5, the communicating part 3, and the flow path 4 communicate one another. The container 8 is formed of a space enclosed by the surface 2c and the upper surface 1a that separately faces the surface 2c. The surface 2c and the upper surface 1a are each formed of a horizontal plane (xy plane). In this case, the upper surface 2a and the bottom surface 1b are also formed of a horizontal plane.

The bottom surface 5b is in parallel to the upper surface 2a. The bottom surface 5b is also in parallel to the bottom surface 2b. The side surface 5c is formed of a vertical plane. The side surface 5c of the recess 5 and the side surface 3c of the communicating part 3 are formed of a continuous surface. The bottom surface 5b is formed of at least part of a plane extending horizontally from the upper opening 4a.

The upper opening 4a is located in the same position as the bottom surface 5b in the vertical direction. The side surface 3c of the communicating part 3 has the same height as the side surface 5c of the recess 5 in the vertical direction. In other words, the side surface 3c of the communicating part 3 is continuous to the side surface 5c of the recess 5. For another example, the upper opening 4a may be located in a position lower than the bottom surface 5b in the vertical direction (z direction). In this case, the bottom surface 5b is formed of at least part of a plane extending horizontally above the upper opening 4a. As the side surface 5c and the side surface 3c are continuous to each other, the recess 5 and the communicating part 3 form one continuous space. The continuous space has a columnar shape with a bottom in the shape of two circles of different radii overlapping at their edges.

In the configuration as described above, an open space is formed over the recess 5, the communicating part 3, and the flow path 4 on the upper surface 10a of the cartridge 10. The open space has an opening in its upper portion and communicates with the container 8. In this embodiment, the upper opening 4a is located in a position as high as or lower than the bottom surface 5b that retains liquid. Accordingly, the liquid retained by the bottom surface 5b serving as a reservoir surface flows into the upper opening 4a at the same height as the reservoir surface through the communicating part 3. Thus, the liquid can be supplied from the recess 5 to the container 8 through the communicating part 3 and the flow path 4.

### [How to Retain Liquid in the Cartridge]

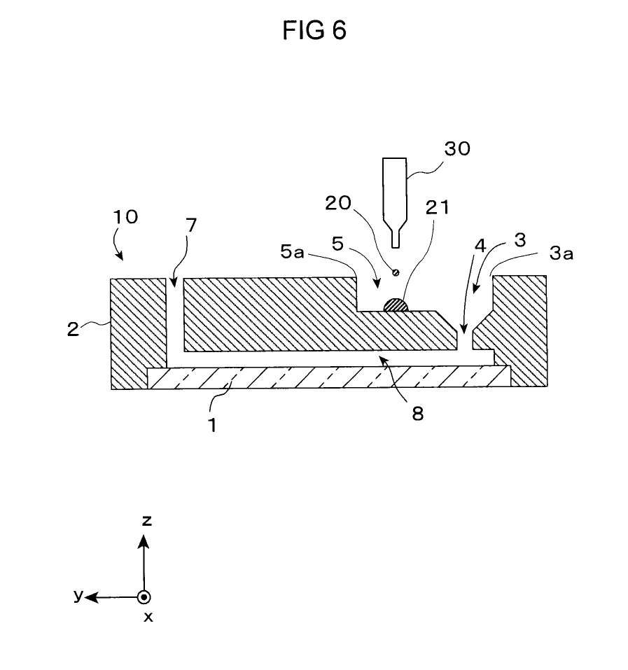

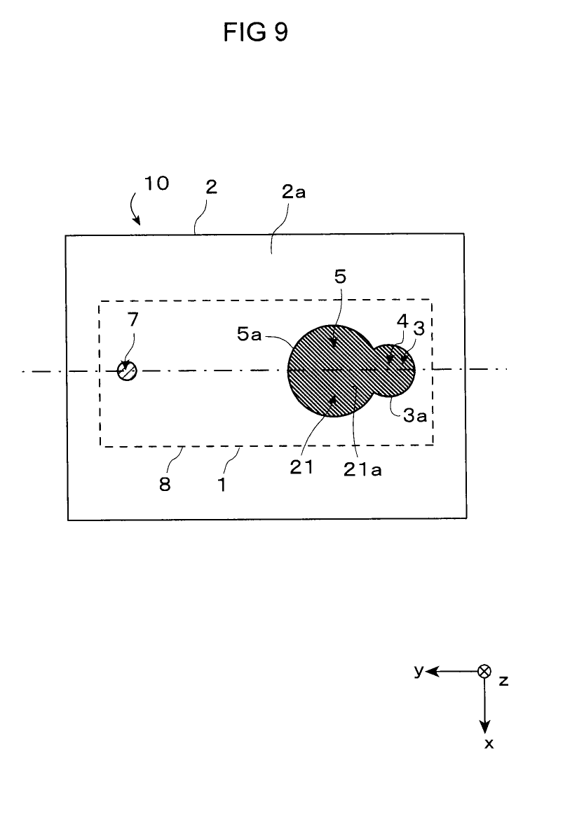

Described below is the operation of retaining liquid in the cartridge 10, in which the cartridge 10 as illustrated in FIGS. 1 to 4 is employed. FIGS. 6 to 11 are schematic diagrams illustrating how to retain liquid in the cartridge 10. FIGS. 6 to 8, 10, and 11 illustrate the operation of supplying a liquid in the cartridge 10 illustrated in FIG. 4. FIG. 9 illustrates the operation of supplying a liquid in the cartridge 10 illustrated in FIG. 3. In the explanation of the operation, the cartridge 10 of FIG. 3 or 4 is used as appropriate. In the drawings, a shaded area is intended to clearly indicate a retention liquid 21, not a cross section.

FIG. 6 illustrates the cartridge 10 at the start of the supply of a liquid thereto. As illustrated in FIG. 6, a droplet 20 is dropped onto the bottom surface 5b from above by, for example, a pipet 30. Having reached the surface, the droplet 20 is retained in the recess 5 as the retention liquid 21. This retention is referred to as “first retention” (a step to retain the liquid).

The liquid dropping position in the bottom surface 5b may be, for example, around the center of the bottom surface 5b. The retention liquid 21 is retained in the bottom surface 5b while adhering to and wetting it. Therefore, if the liquid dropping position is located around the center of the bottom surface 5b, droplets of the retention liquid 21 grow uniformly on the bottom surface 5b. Thus, the recess 5 can retain more liquid.

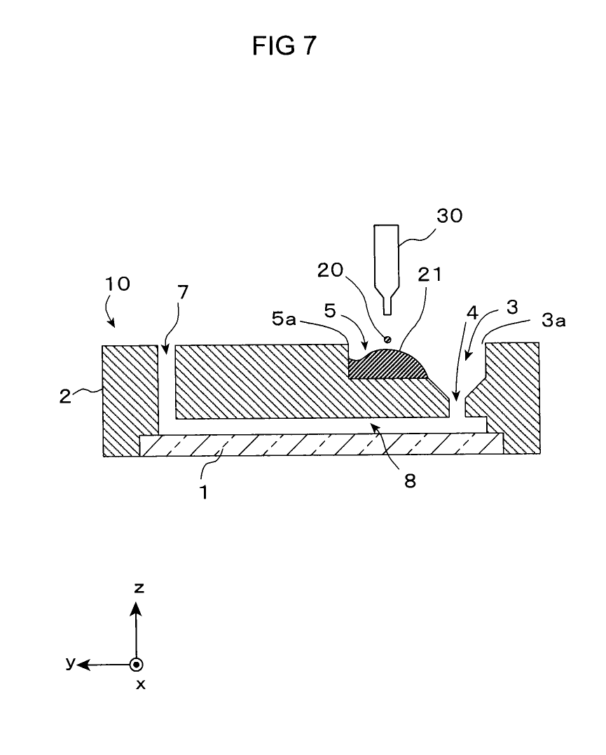

FIG. 7 illustrates the cartridge 10 when a plurality of the droplets 20 is dropped onto the bottom surface 5b. As illustrated in FIG. 7, the droplets 20 that have fallen on the bottom surface 5b increase the retention liquid 21 in the recess 5. At this time, the retention liquid 21 adheres to the side surface 5c as well as the bottom surface 5b. For example, as adhering to the side surface 5c, the retention liquid 21 is bound to the side surface 5c. At this point, droplets of the retention liquid 21 are held by surface tension generated at the edge 5e. Besides, when the retention liquid 21 adheres to the side surface 5c, droplets of the retention liquid 21 are held by the binding force of the side surface 5c and the bottom surface 5b. Examples of the binding force include interfacial tension between the liquid and the side surface 5c, resistance due to viscosity, and the like. For example, an upward force is applied to the retention liquid 21 adhering to the side surface 5c by interfacial tension present at the interface.

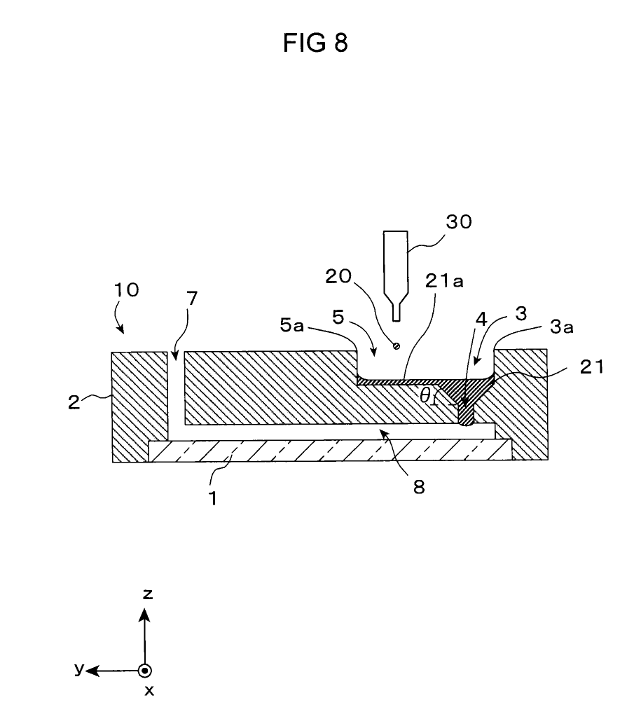

FIG. 8 is a cross-sectional view illustrating a state where the droplets of the retention liquid 21 collapse in the recess 5 and then the retention liquid 21 flows into the flow path 4. FIG. 9 is a top view of the cartridge 10 in the state illustrated in FIG. 8. When the amount of the retention liquid 21 in the recess 5 exceeds a predetermined value, the retention liquid 21 flows into the upper opening 4a (a step to let the liquid flow into the opening). As illustrated in FIG. 8, while the retention liquid 21 flows into the flow path 4, the flow stops at the lower opening 4c. Thus, the retention liquid 21 is retained in the entire flow path 4 and a space formed by the recess 5 and the communicating part 3. That is, the flow path 4 is filled with the retention liquid 21, and also the retention liquid 21 is retained in a space formed by the recess 5 and the communicating part 3 with a predetermined liquid level. For example, as illustrated in FIG. 9, the retention liquid 21 is retained in the entire space formed by the recess 5 and the communicating part 3 in the horizontal direction (xy direction). This retention is referred to as “second retention”. Specifically, in the second retention, the retention liquid 21 is retained in the flow path 4 as well as a continuous space formed by the recess 5 and the communicating part 3.

For example, the volume of the recess 5 and that of the flow path 4 are determined taking into account the second retention that occurs when the retention liquid 21 retained by the first retention flows into the flow path 4. For example, the recess 5 is designed such that the volume of liquid retained by the first retention is larger than at least the volume of the flow path 4. Further, the recess 5 is formed to retain by the first retention a sufficient amount of liquid that permeates through a space formed by the recess 5 and the communicating part 3. That is, in the second retention, the liquid is retained in a space formed by the recess 5 and the communicating part 3 with a predetermined liquid level. For example, the shape, material and the like of the recess 5 are determined such that the volume of liquid retained by the first retention is larger than at least the volume of the flow path 4. Further, for example, the shape, material and the like of the recess 5 are determined such that the volume of liquid retained by the first retention is larger than the sum of the volume of the flow path 4 and a volume calculated from the product of the area of the bottom surface 5b and the upper opening 4a and a height at the predetermined liquid level.

The bottom surface 5b and the side surface 5c are designed as appropriate under conditions to allow the recess 5 to retain such amount of liquid as described above. For example, the conditions may be determined experimentally or may be determined theoretically in consideration of the properties of liquid, the wetting properties of the contact surface to be in contact with the liquid, and the like. The conditions may also be determined from the combination of these. The conditions include the shape, material and the like of the bottom surface 5b and the side surface 5c.

The liquid inlet hole 4b may be designed as appropriate such that, when the retention liquid 21 retained by the first retention flows into the flow path 4, it does not run off from the lower opening 4c. This design may be determined as appropriate under predetermined conditions. For example, the conditions may be determined experimentally from an experiment or may be determined theoretically. The conditions include, for example, the shape, material and the like of the liquid inlet hole 4b.

In a theoretical manner, the conditions are determined in consideration of, for example, a balance between a force applied downward to the retention liquid 21 and a force applied upward. To prevent the retention liquid 21 that has flowed into the flow path 4 from running off from the lower opening 4c, at least it is required that the upward force from the liquid inlet hole 4b is larger than the downward force applied to the retention liquid 21. That is, the liquid inlet hole 4b may be designed under the conditions that make the upward force applied from the liquid inlet hole 4b to the retention liquid 21 in the flow path 4 is larger than the gravity applied thereto. Examples of the upward force include interfacial tension (surface tension), resistance due to viscosity, air pressure in the container 8, and the like. If, for example, interfacial tension is used as a condition, the liquid inlet hole 4b is configured to apply an upward interfacial tension to the retention liquid 21. Specifically, for example, the liquid inlet hole 4b is formed of a surface having wetting properties that generate the interfacial tension. In addition, for example, the through hole 7b of the air discharge path 7 may be designed as appropriate to adjust the pressure in the container 8, the pressure variation, and the like.

The liquid inlet hole 4b includes the tapered part 4d and the straight tube part 4e. The vertical length of the tapered part 4d is determined to be shorter than that of the straight tube part 4e. Note that the vertical length of the tapered part 4d may be longer than that of the straight tube part 4e. Besides, the liquid inlet hole 4b is designed such that the tapered part 4d thereof has a taper angle θ in a predetermined range. The taper angle θ is defined by an angle formed by the tapered part 4d and a horizontal line. The liquid inlet hole 4b may include only the tapered part 4d. In this case, for example, the liquid inlet hole 4b has the shape of a circular truncated cone.

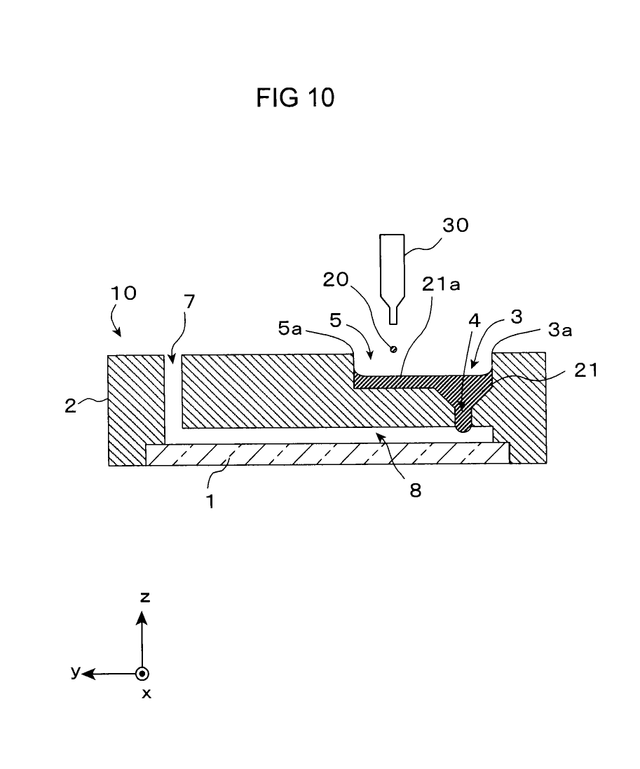

FIG. 10 illustrates a state where the droplets 20 are dropped to a liquid surface 21a after the retention liquid 21 has flowed into the flow path 4. As illustrated in FIG. 10, even when a plurality of the droplets 20 is dropped to the liquid surface 21a, the retention liquid 21 does not flow into the container 8 through the lower opening 4c, and the second retention continues. This results in the rise of the liquid level of the retention liquid 21 that is retained in a space formed by the recess 5 and the communicating part 3. The rise of the liquid level increases the downward force of gravity applied to the retention liquid 21.

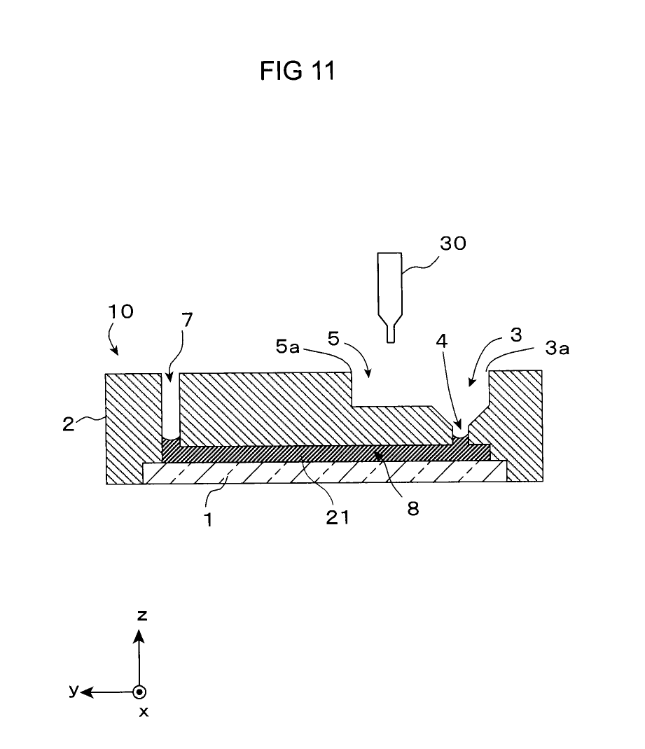

FIG. 11 illustrates a state where the droplets 20 are further dropped onto the liquid surface 21a. As illustrated in FIG. 11, the retention liquid 21 flows into the container 8 from the flow path 4, and the container 8 is filled with the retention liquid 21. This is presumably because the force balance is lost in the flow path 4. Due to the loss of the force balance, the retention liquid 21 retained by the second retention flows at once into the container 8 (a step of retaining the liquid). At this time, the air in the container 8 is discharged to the outside through the air discharge path 7. Thus, the container 8 can be filled with the liquid.

Assuming that the volumes of the recess 5, the flow path 4, and the container 8 are represented by V1, V2, and V3, their relationship is expressed as follows: V1≧V2 and (V1+V2)>V3. With this relationship, the recess 5 retains the retention liquid 21 in a sufficient amount with respect to the size of the lower opening 4c. Accordingly, even if the retention liquid 21 increases due to the addition of droplets by the second retention, the retention liquid 21 can be held at the lower opening 4c. Further, when the retention liquid 21 is introduced into the container 8 after the second retention, the amount of the retention liquid 21 is larger than the volume of the container 8, and therefore the container 8 is filled with the retention liquid 21 at once.

Here, the amount of the retention liquid 21 retained by the second retention needs to be larger than the volume of the container 8 to fill the container 8 with the retention liquid 21. For this reason, for example, the volume of the container 8 is set to the volume of liquid that can be retained by the second retention or less. If the volume of the container 8 is set in advance, the liquid inlet hole 4b is designed as appropriate under conditions that make the amount of liquid retained by the second retention equal to or larger than the volume of the container 8. As described above, the conditions may be determined experimentally or may be determined theoretically in consideration of the force balance or the like. The conditions may also be determined from the combination of these.

Described below are modifications of the cartridge for inspection apparatus of the embodiment.

### <First Modification>

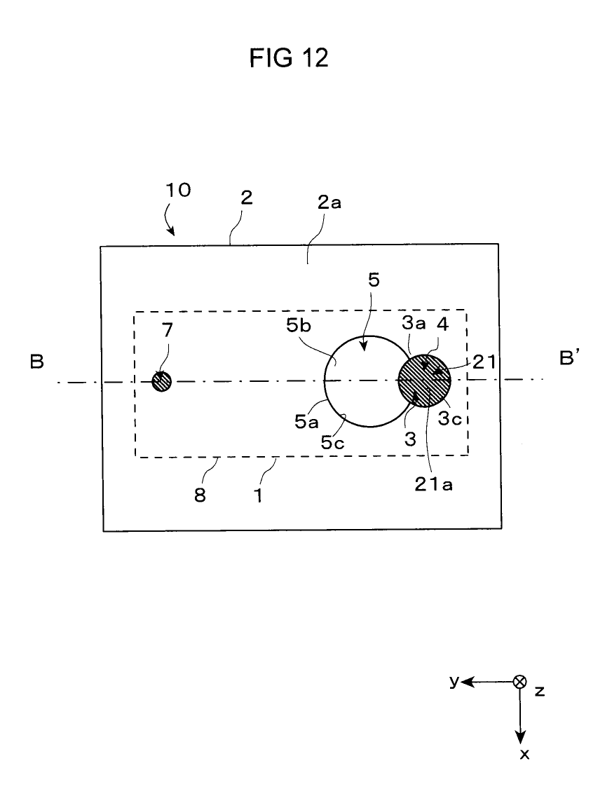

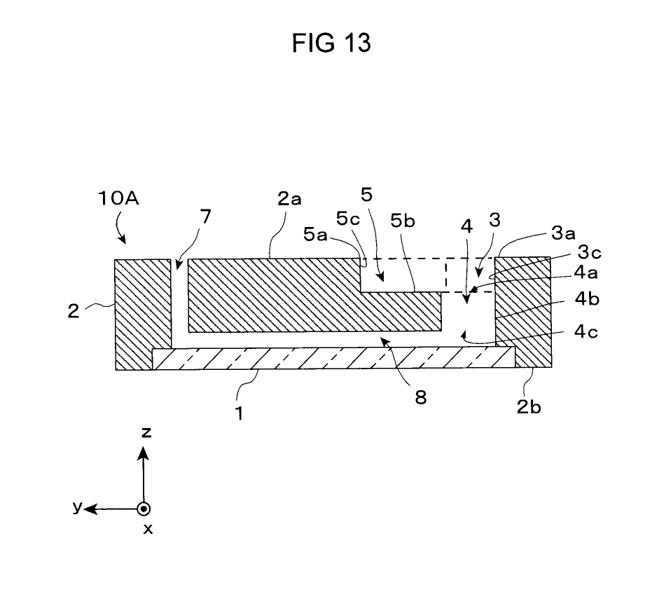

FIG. 12 is a top view of a cartridge 10A for inspection apparatus according to a first modification. FIG. 13 is a cross-sectional view of the cartridge 10A of the first modification. Specifically, FIG. 13 is a vertical cross section taken along line B-B′ of FIG. 12.

As illustrated in FIGS. 12 and 13, the cartridge 10A has the liquid inlet hole 4b that extends vertically in a straight tube shape differently from the cartridge 10 illustrated in FIGS. 1 to 4. That is, the liquid inlet hole 4b does not have the tapered part 4d. In this modification, the opening of the liquid inlet hole 4b has a size along the side surface 3c of the communicating part 3. Accordingly, in the cartridge 10 illustrated in FIGS. 1 to 4, the lower opening 4c is in the same size as the upper opening 4a. Otherwise, the cartridge 10A may be of basically the same configuration as the cartridge 10.

### <Second Modification>

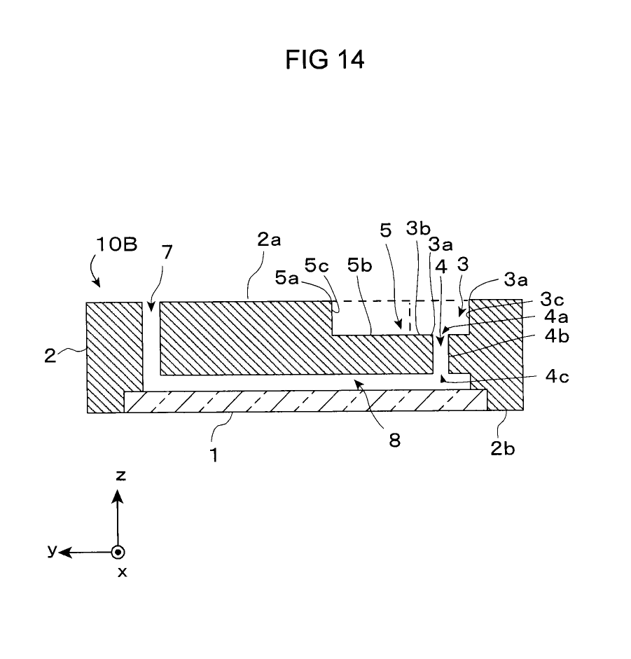

FIG. 14 is a cross-sectional view of a cartridge 10B for inspection apparatus according to a second modification. As illustrated in FIG. 14, the cartridge 10B has the liquid inlet hole 4b that extends vertically in a straight tube shape differently from the cartridge 10 illustrated in FIGS. 1 to 4. That is, the liquid inlet hole 4b does not have the tapered part 4d. In this modification, in the cartridge 10 illustrated in FIGS. 1 to 4, the lower opening 4c is in the same size as the upper opening 4a. Accordingly, the communicating part 3 is defined by the side surface 3c and a bottom surface 3b. The upper opening 4a is located in the center of the bottom surface 3b. In the first and second modifications, the size of the upper opening 4a and the lower opening 4c may be determined as appropriate in consideration of the above conditions for the first and second retentions. Otherwise, the cartridge 10B may be of basically the same configuration as the cartridge 10.

### <Third Modification>

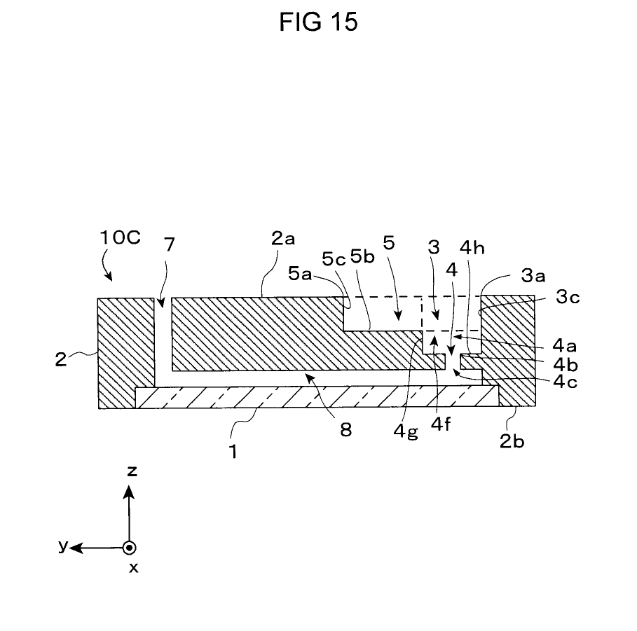

FIG. 15 is a cross-sectional view of a cartridge 10C for inspection apparatus according to a third modification. As illustrated in FIG. 15, the cartridge 10C has the liquid inlet hole 4b that includes a concave part 4f in place of the tapered part 4d differently from the cartridge 10 illustrated in FIGS. 1 to 4. The concave part 4f is a space defined by a bottom surface 4h and a side surface 4g. For example, the upper portion of the concave part 4f is formed in the same shape as the bottom of the communicating part 3. The bottom surface 4h is formed of, for example, a horizontal plane. The side surface 4g is, for example, a vertical surface and extends along the side surface 3c. The height of the side surface 4g is determined as appropriate. The shape, depth, and the like of the concave part 4f may be determined as appropriate in consideration of the above conditions for the first and second retentions. Based on this determination, the bottom surface 4h and the side surface 4g are formed. Otherwise, the cartridge 10C may be of basically the same configuration as the cartridge 10.

### <Fourth Modification>

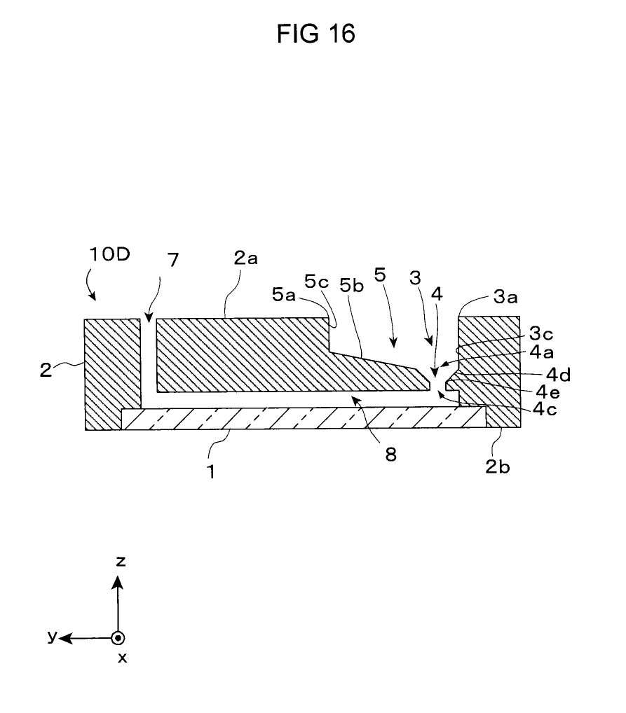

FIG. 16 is a cross-sectional view of a cartridge 10D for inspection apparatus according to a fourth modification. As illustrated in FIG. 16, the cartridge 10D has the inclined bottom surface 5b as a reservoir surface differently from those illustrated in FIGS. 1 to 4 and 12 to 15. The bottom surface 5b is inclined in the longitudinal direction of the container 8. In other words, the bottom surface 5b is inclined in a direction in which the retention liquid (liquid) flows from the recess 5 into the flow path 4. The bottom surface 5b need not necessarily be inclined in this direction. The inclination angle may be determined as appropriate in consideration of the above conditions for the first and second retentions. Thus, by the inclination of the bottom surface 5b, it is possible to control the amount of liquid retained in the recess 5 until the liquid flows into the upper opening 4a. This reduces unnecessary liquid remaining in the recess 5. Otherwise, the cartridge 10D may be of basically the same configuration as the cartridge 10 (10A to 10C).

### <Fifth Modification>

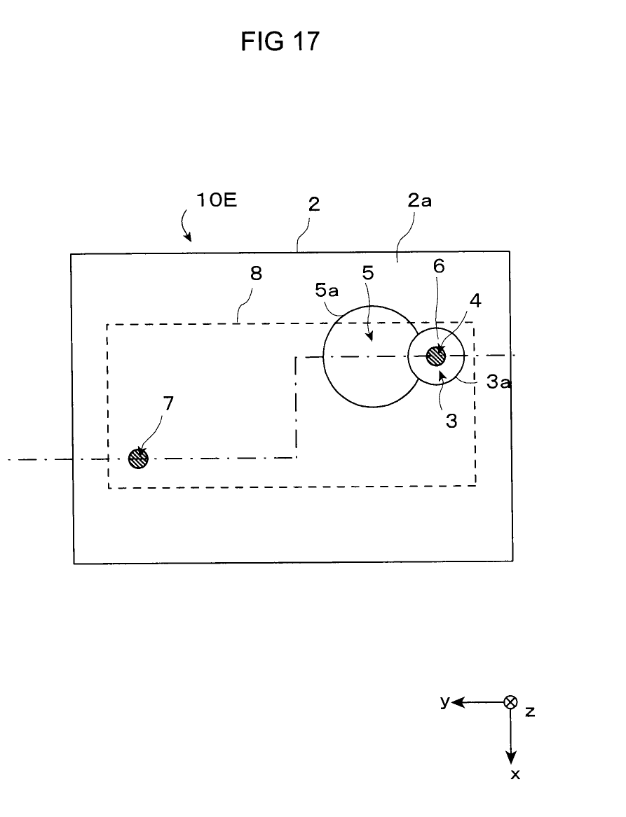

FIG. 17 is a top view of a cartridge 10E for inspection apparatus according to a fifth modification. As illustrated in FIG. 17, in the cartridge 10E, the positions of the flow path 4 and the air discharge path 7 are arbitrarily set differently from those illustrated in FIGS. 1 to 4 and 12 to 15. That is, FIG. 17 illustrates a configuration other than the one in which the center axis of the bottom surface 5b in the x direction (the lateral direction of the container 8) and a line segment that connect the center of the upper opening 4a and the center of the upper opening 7a lie in the same straight line.

As illustrated in FIG. 17, on the upper surface 2a, the liquid inlet hole 4b of the flow path 4 is located in a position corresponding to the vicinity of one longitudinal edge as well as one lateral edge of the container 8 in a region corresponding to the container 8. Besides, the through hole 7b of the air discharge path 7 is located in a position corresponding to the vicinity of the other longitudinal edge as well as the other lateral edge of the container 8 in the region corresponding to the container 8. The through hole 7b extends downward. Thus, the lower opening 7c and the lower opening 4c in the surface 2c that forms the upper surface of the container 8 are diagonally located on the horizontal plane (xy plane) of the container 8. With this configuration, the liquid that has introduced into the container 8 through the upper opening 4a runs swiftly toward the air discharge path 7, and bubbles are less likely to remain in the container 8 as a detection space. Otherwise, the cartridge 10D may be of basically the same configuration as the cartridge 10 (10A to 10D).

The shape of the cartridge of this embodiment is not limited to a rectangular parallelepiped shape. Examples of the shape of the cartridge include various columnar shapes and frustum shapes having an inclined side surface. For example, if determined as a front surface among a plurality of surfaces, the side surface 2d is inclined forward in the y direction. With this, the area of the upper surface 10a is smaller than that of the bottom surface 10b. Thus, the operator can distinguish between the front and back of the cartridge 10.

According to the embodiment, the cartridge for inspection apparatus includes a recess that retains a predetermined amount of liquid in a position adjacent to the upper opening 4a for introducing the liquid therein. The liquid is dropped onto the recess to be retained, and is supplied to the upper opening 4a at once. Triggered by the overflow of retained liquid to the upper opening 4a, the liquid is retained at once in the container 8 as a detection space. Thus, by simply dropping droplets of the liquid onto the bottom surface 5b as a reservoir surface, the liquid can be introduced at once into the container 8 as a sensor. Further, since the liquid is once retained and then introduced at once into the container 8 as a sensor, the introduction of the liquid is not affected by time intervals of dropping the droplets. Therefore, even if the density varies with each droplet, the density distribution is less likely to occur. In addition, since the liquid is introduced at once into the container 8, the measurement start point is kept constant for each measurement.

### Second Embodiment

### [Cartridge for Inspection Apparatus]

The cartridge for inspection apparatus according to a second embodiment has the configuration of the cartridge of the first embodiment, in which the first recessed surface 5a and the second recessed surface 3a are formed separate from each other, and a communicating path is further provided to connect the first recessed surface 5a and the second recessed surface 3a. The bottom surfaces of the first recessed surface 5a, the communicating path, and the second recessed surface 3a are formed by a continuous plane. The second recessed surface 3a has a through hole in its bottom surface.

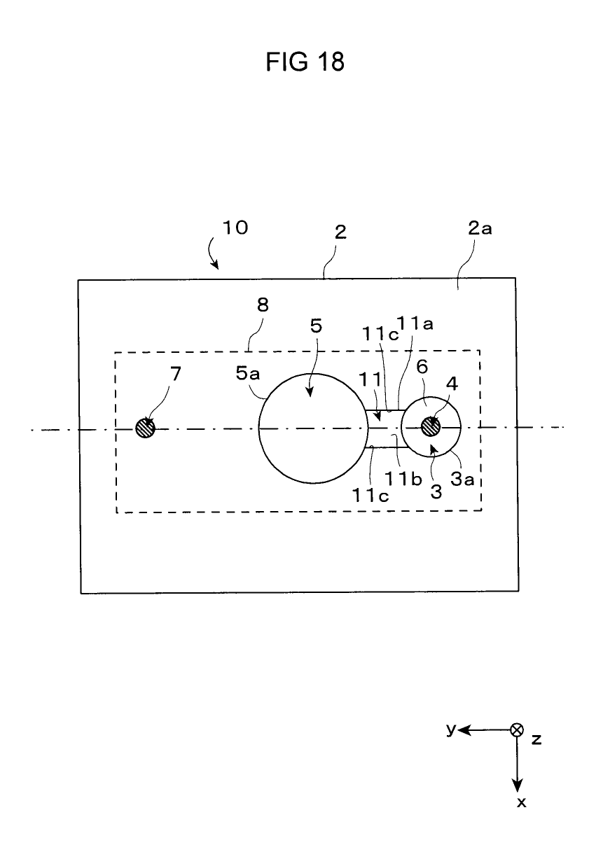

FIG. 18 is a top view of an example of the cartridge 10 for inspection apparatus of the second embodiment. As illustrated in FIG. 18, the first recessed surface 5a that defines the recess 5 is formed separate from the second recessed surface 3a that defines the communicating part 3. The first recessed surface 5a and the second recessed surface 3a are connected via a communicating path 11a that defines a communicating space 11. The communicating path 11a is formed in a groove shape (channel shape) including a bottom surface 11b and side surfaces 11c extending in the longitudinal direction of the container 8 (y direction) along the sides of the bottom surface 11b. The communicating path 11a is arranged, for example, such that its center axis in the lateral directions of the container 8 (x direction) lies in the same straight line as the center of the recess 5 and the center of the upper opening 4a. Besides, for example, the bottom surface 5b, the bottom surface 11b, and the upper opening 4a are located at the same vertical height. The bottom surface 5b, the bottom surface 11b, and the upper opening 4a may be formed to be lower in this order. In the cartridge 10 of the embodiment, the bottom surface 5b is not adjacent to the upper opening 4a and therefore has a circular shape.

Otherwise, the cartridge 10 of this embodiment may be of basically the same configuration as described in the first embodiment. In addition, the cartridge 10 of this embodiment may be supplied with a liquid in the same manner as described in the first embodiment.

### Third Embodiment

The cartridge for inspection apparatus according to a third embodiment has the configuration of the cartridge of the first embodiment, in which the first recessed surface 5a is provide with a through hole in the bottom surface and no second recessed surface is present.

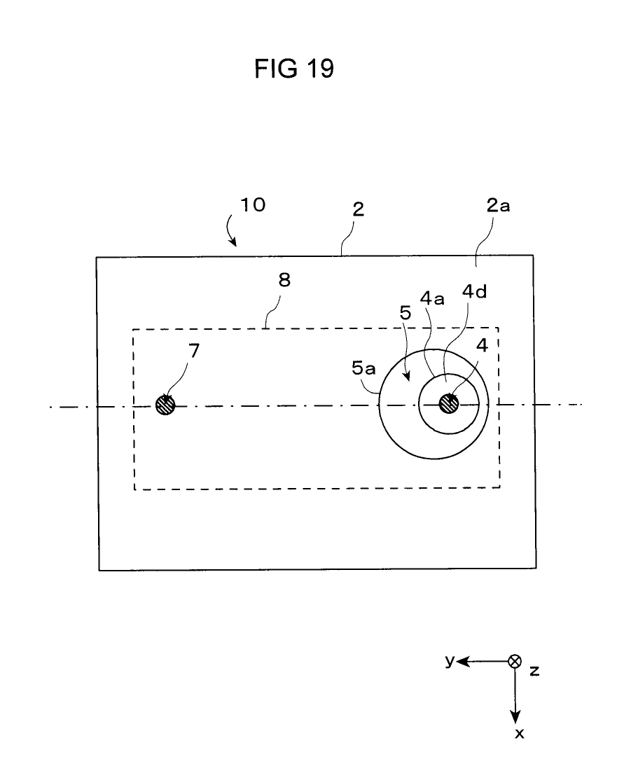

FIG. 19 is a top view of an example of the cartridge 10 for inspection apparatus of the third embodiment. As illustrated in FIG. 19, the upper opening 4a and the liquid inlet hole 4b are formed in the bottom surface 5b to define the flow path 4 that communicates between the container 8 and the outside. The upper opening 4a is located in a position where its center is away from the center of the bottom surface 5b. In this case, for example, the liquid dropping position is set on the bottom surface 5b in a region with a longer distance between the side surface 5c and the outer periphery of the upper opening 4a.

Otherwise, the cartridge 10 of this embodiment may be of basically the same configuration as described in the first embodiment. In addition, the cartridge 10 of this embodiment may be supplied with a liquid in the same manner as described in the first embodiment.

### Fourth Embodiment

The cartridge for inspection apparatus according to a fourth embodiment has the configuration of the cartridge of the first embodiment, in which the upper surface 2a serves as the bottom surface of the first recessed surface 5a and the second recessed surface 3a. Further, the side surface of the first recessed surface 5a and the second recessed surface 3a is formed of a protrusion provided on the upper surface 2a. That is, the first recessed surface 5a and the second recessed surface 3a are formed by providing the upper surface 2a with the protrusion.

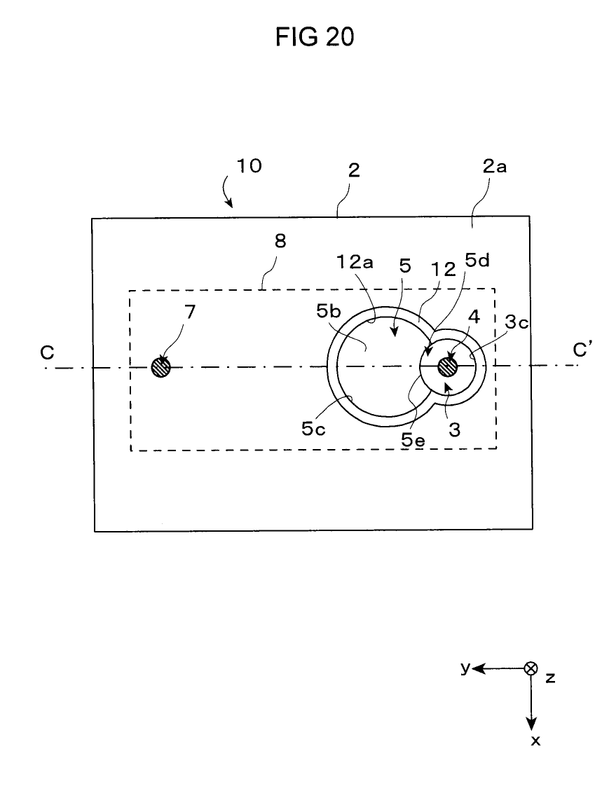

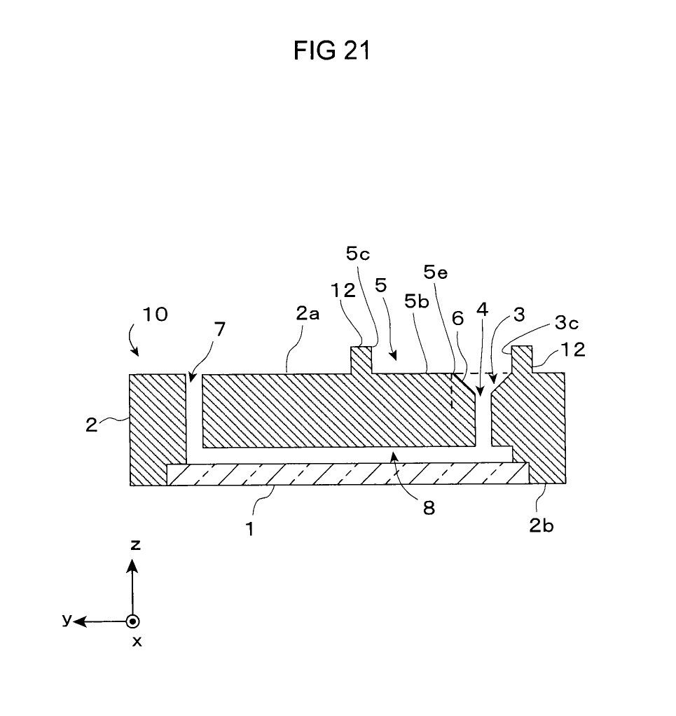

FIG. 20 is a top view of an example of the cartridge 10 for inspection apparatus of the fourth embodiment. FIG. 21 is a cross-sectional view of the cartridge 10 of the embodiment. Specifically, FIG. 21 is a vertical cross section taken along line C-C′ of FIG. 20.

As illustrated in FIGS. 20 and 21, the upper surface 2a is provided with a protrusion 12 that encloses the bottom surface 5b and the upper opening 4a. The protrusion 12 extends along the edges of the bottom surface 5b and the upper opening 4a except the edge 5e. An inner peripheral surface 12a of the protrusion 12 forms the side surface 5c and the side surface 3c. The recess 5 is formed of part of the inner peripheral surface 12a of the protrusion 12 and the bottom surface 5b.

Otherwise, the cartridge 10 of this embodiment may be of basically the same configuration as described in any of the first to third embodiments. In addition, the cartridge 10 of this embodiment may be supplied with a liquid in the same manner as described in the first embodiment.

### Fifth Embodiment

The cartridge for inspection apparatus according to a fifth embodiment has the configuration of the cartridge of any one of the first to fourth embodiments, which further includes a plurality of the through holes 7b each defining the air discharge path 7.

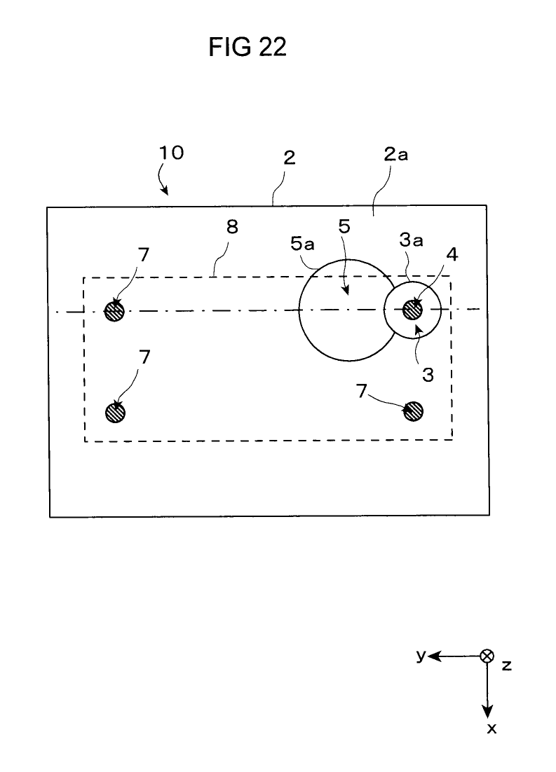

FIG. 22 is a top view of an example of the cartridge 10 for inspection apparatus of the fifth embodiment. As illustrated in FIG. 22, in the region corresponding to the container 8 on the upper surface 2a, through holes are formed each in a position corresponding to the vicinity of each corner of the container 8. One of the through holes defines the flow path 4, while the others define the air discharge paths 7. In this case, since the region corresponding to the container 8 is rectangular, there are four positions that correspond to the vicinity of the corners of the container 8. Thus, the upper surface 2a has the one upper opening 4a and three upper openings (7a). The three upper openings include the upper opening 7a located in series with and away from the upper opening 4a in the longitudinal direction of the container 8 and the upper opening 7a located in series with and away from the upper opening 4a in the lateral direction of the container 8. The rest of them is the upper opening 7a located in a position diagonal to the upper opening 4a. Accordingly, a shape obtained by connecting the center of the upper opening 4a and the centers of the three upper openings 7a together is similar to the shape of the container 8. The liquid inlet hole 4b and the through hole 7b extend vertically. Accordingly, the air discharge path 7 communicates with the container 8 at horizontally the same location (in the xy direction) as the upper opening 7a in the upper surface 2a.

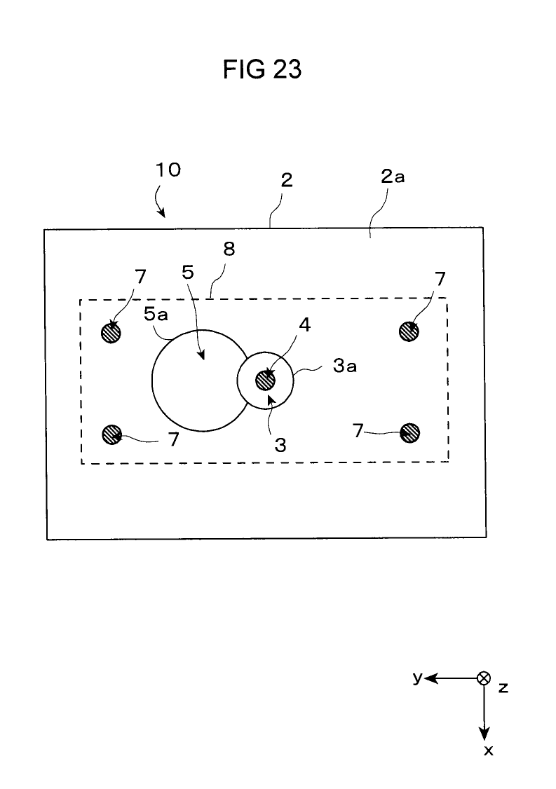

FIG. 23 is a top view of another example of the cartridge 10 of the fifth embodiment. As illustrated in FIG. 23, in the region corresponding to the container 8 on the upper surface 2a, through holes (7b) each defining the air discharge path 7 are formed in the positions corresponding to the vicinity of the corners of the container 8. Besides, the liquid inlet hole 4b that defines the flow path 4 is arranged in the center of the region. In this case, since the region corresponding to the container 8 is rectangular, there are four positions that correspond to the vicinity of the corners of the container 8. On the upper surface 2a, the center of the upper opening 4a is set to a position such that the through holes 7b are separated from the liquid inlet hole 4b by the same distance. For example, the center of the upper opening 4a is set to a position on the intersection of diagonal lines connecting the four upper openings 7a.

Otherwise, the cartridge 10 of this embodiment may be of basically the same configuration as described in any of the first to fourth embodiments. In addition, the cartridge 10 of this embodiment may be supplied with a liquid in the same manner as described in the first embodiment.

According to the embodiment, the cartridge for inspection apparatus further includes a plurality of the through holes 7b each defining the air discharge path 7 in addition to the configuration described in the first to fourth embodiments. Since at least two through holes (7b) are present near the corners of the container 8 for discharging the air, bubbles are further less likely to remain in the vicinity of the corners of the container 8 as a detection space. Besides, the through hole 7b is formed in the vicinity of each corner of the container 8 for discharging the air, and the liquid inlet hole 4b is arranged in a position corresponding to the center of the container 8 for introducing a liquid to the inside. Accordingly, the through holes 7b for discharging the air are separated from the liquid inlet hole 4b for introducing a liquid by the same distance. Thus, the container can be swiftly filled with the liquid.

### Sixth Embodiment

The cartridge for inspection apparatus according to a sixth embodiment has the configuration of the cartridge of any one of the first to fifth embodiments, in which a plurality of grooves is formed in a region other than the first and second recessed parts on the upper surface 2a. The groove is formed to prevent a liquid from flowing into the through hole 7b for discharging the air.

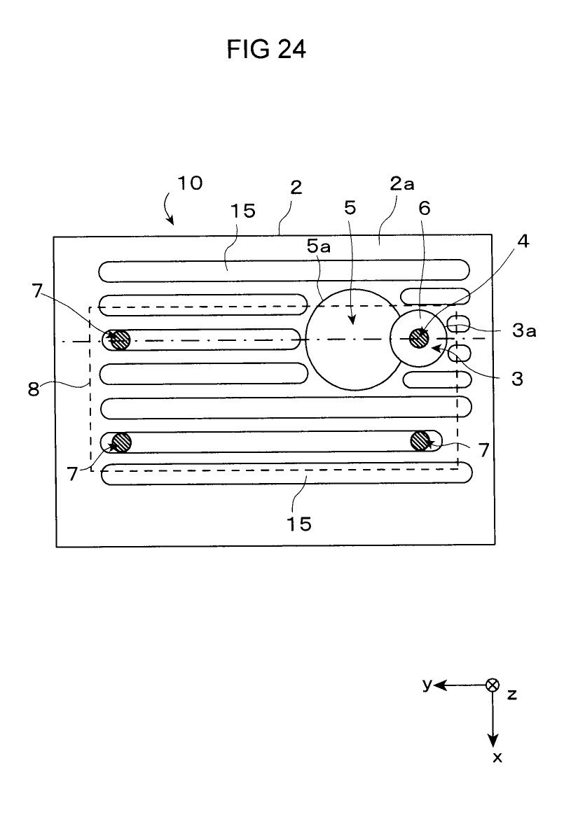

FIG. 24 is a top view of an example of the cartridge 10 for inspection apparatus of the sixth embodiment. As illustrated in FIG. 24, the upper surface 2a is provides with a plurality of grooves 15 each formed in an elongated shape extending in the longitudinal direction of the container 8. The grooves 15 are arranged at predetermined intervals, thereby forming as a whole a rib structure in which concave and convex parts are alternately formed. The grooves 15 are provided not to penetrate through the side surface 5c and the side surface 3c. At least one groove (15) is provided between the bottom surface 5b as a reservoir surface and the through hole 7b for discharging the air.

Otherwise, the cartridge 10 of this embodiment may be of basically the same configuration as described in any of the first to fifth embodiments. In addition, the cartridge 10 of this embodiment may be supplied with a liquid in the same manner as described in the first embodiment.

According to the embodiment, the cartridge for inspection apparatus further includes a plurality of the through holes 7b each defining the air discharge path 7 in addition to the configuration described in the first to fourth embodiments. Moreover, a plurality of grooves is formed in a region other than the first and second recessed parts on the upper surface 2a. Accordingly, for example, when a liquid is dropped onto the bottom surface 5b, droplets of the liquid that have landed on a position outside the bottom surface 5b can be caught by the grooves 15 before they reach the through holes 7b as flowing on the upper surface 2a. In addition, if the liquid overflows from the recess 5, the liquid can be caught by the grooves 15 before reaching the through holes 7b as flowing on the upper surface 2a.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A cartridge for inspection apparatus, comprising:
a container configured to contain a liquid and including a bottom surface having a functional layer that is reactive to a test sample contained in the liquid;
a flow path including an opening above the container and configured to introduce the liquid that has flowed therein from the opening to the container; and
a reservoir configured to retain the liquid and including an opening that is larger than the opening of the flow path and a bottom surface that is connected to the opening of the flow path.

2. The cartridge of claim 1, wherein the reservoir has a recessed shape having a depth from the opening to the bottom surface smaller than the opening.

3. The cartridge of claim 1, wherein the bottom surface of the reservoir is substantially horizontal.

4. The cartridge of claim 1, wherein the opening of the flow path is located in the bottom surface of the reservoir.

5. The cartridge of claim 4, wherein the opening of the flow path is located in a position deviated from center of the bottom surface of the reservoir.

6. The cartridge of claim 5, wherein the opening of the flow path is located in an edge of the bottom surface of the reservoir.

7. The cartridge of claim 1, wherein the opening of the flow path includes an inclined surface that is connected to the bottom surface of the reservoir.

8. The cartridge of claim 1, wherein the opening of the flow path is at least partly connected to the opening of the reservoir.

9. The cartridge of claim 1, wherein the bottom surface of the container has translucency.

10. A method of retaining liquid in a cartridge for inspection apparatus that includes a container configured to retain a liquid that contains a test sample, a reservoir configured to retain the liquid to be retained in the container, and an opening where the liquid retained in the reservoir flows in, the method comprising:
dropping the liquid onto the reservoir to retain the liquid in the reservoir;
further dropping the liquid onto the reservoir to let the liquid retained in the reservoir flow into the opening; and
retaining the liquid that has flowed into the opening in the container.

11. A cartridge for inspection apparatus, comprising:
a container part including a chip having an optical waveguide and attached to one side of the container part, which forms a container configured to contain a liquid;
a liquid inlet hole located on another side of the container part;
a reservoir configured to retain the liquid and located on the other side of the container part; and
a recess located in the reservoir and connected to the liquid inlet hole, the recess including a bottom having an area larger than an opening area of the liquid inlet hole, wherein
the liquid retained in the recess is introduced to the container through the liquid inlet hole.

12. The cartridge of claim 11, wherein the liquid inlet hole is located in a position deviated from center of the recess.

13. The cartridge of claim 12, wherein the liquid inlet hole is located in an edge of the recess.

14. The cartridge of claim 11, wherein the bottom of the recess has a circular shape.

15. The cartridge of claim 11, wherein
the liquid inlet hole is located in an end part of the container, and
the recess is located closer to center of the container than the liquid inlet hole.
